(19) United States
(12) Patent Application Publication
(10) Pub. No.: US 2022/0125244 A1
(43) Pub. Date: Apr. 28, 2022

(54) Pie Iron Preparation System

(71) Applicants: Gregory Yearick, Centre Hall, PA (US); LuAnn Yearick, Centre Hall, PA (US)

(72) Inventors: Gregory Yearick, Centre Hall, PA (US); LuAnn Yearick, Centre Hall, PA (US)

(21) Appl. No.: 17/511,604

(22) Filed: Oct. 27, 2021

Related U.S. Application Data
(60) Provisional application No. 63/106,338, filed on Oct. 27, 2020.

(51) Int. Cl. A47J 37/07; A47J 37/06; A47J 36/02; A47J 33/00

(52) U.S. Cl. CPC A47J 37/0772; A47J 37/0611; A47J 2037/0777; A47J 33/00; A47J 36/025

(57) ABSTRACT

A pie iron preparation system may be provided comprising a base substrate, a lid and one or more hinges. The base substrate may have a first elongate length-to-width dimensional ratio and may comprise a top surface that comprises one or more pie iron depressions formed therein. The lid may have the first elongate length-to-width dimensional ratio and may comprise a plurality of walls disposed at a perimeter edge thereof. The plurality of walls may surround a work surface disposed upon a first side of the lid. The one or more hinges may operably couple the base substrate to the lid.

### CROSS-REFERENCE TO RELATED APPLICATIONS

This application claims priority to U.S. Provisional Patent Application Ser. No. 63/106,338 entitled “Pie Iron Preparation System,” filed Oct. 27, 2020. The contents of this application are hereby incorporated by reference in their entirety.

### BACKGROUND OF THE INVENTION

Pie irons in their historic form have been in use within residential and outdoors environments for over a century but are primarily utilized in countries having British colonial roots. For instance, in Australia, a pie iron is referred to as a jaffle iron or jaffle maker, in the UK, a toastie maker and, in South Africa, a snackwich maker. Generally, a pie iron is a cooking appliance that may comprise a metal food mold that can be separated and sealed via relative manipulation of two elongate handles operably coupled via a rotating hinge.

In use, the pie iron is placed into its sealed configuration after the desired food contents have been arranged within the food mold. Thereafter, the pie iron may be placed into a heated environment such as an open-air fire, a fireplace, a wood burning stove and the like. Upon cooking a desired amount of time, the pie iron is removed from the heated environment and the food contents are extracted from the food mold upon the food mold being placed in the separated configuration. Electronic versions of the pie iron exist, but these models cook the food contents in a different manner than the externally-applied thermal energy and are not practical in an outdoors environment where electricity is not readily available.

One of the main use cases for pie irons within the modern context is in the recreational camping setting. The use of pie irons within the camping setting provides the camper with a means of producing hot food within a sealed container that can be cooked within the campfire. Further, the use of the pie iron provides the camper with a sense of rugged living and a look into the life of a frontiersman exploring the area centuries ago.

Moreover, the market for camping equipment was estimated at nearly $14 billion dollars in 2020 and is expected to increase sharply given the restrictions on indoor event settings and the accelerated trend of the net exodus of population from most urban centers to more rural settings. Inherently correlated with this trend is the camping accessory market which historically follows the same trend lines as the general camping equipment market. Moreover, pie irons may be utilized in residential settings as well where the campfire can be replaced as the heating element by a fireplace, a stovetop, an outdoor fire container, a fire pit and the like.

However, some common issues campers face when using pie irons are: 1) the messiness associated with using the pie iron as a cooking implement, 2) the difficult cleanup process after cooking with the pie iron, 3) the propensity for the cooked food contents to stick to the interior walls of the pie iron, 4) the lack of safety equipment provided to the user when handling a hot pie iron and removing the cooked food contents therefrom, 5) the lack of preparation equipment and space provided to the user when preparing the food contents within the pie iron prior to cooking in the campfire, and 6) the lack of a means of portably transporting the pie iron before and after the camping experience.

The present invention solves these problems by providing a pie iron preparation system that enables the user to organize the preparation of food contents for the pie iron, thereby minimizing the typical messiness of pie irons. Further, the pie iron preparation system advantageously comprises a plurality of non-stick surfaces where pie iron food contents would typically stick if using traditional surface materials like cast iron, thereby reducing the burden of the cleanup process after using the pie iron. Additionally, the pie iron preparation system may comprise one or more pie iron molds that are robust to high temperatures for retaining the hot pie iron therein for safe handling and removal of cooked food contents therefrom. Moreover, the pie iron preparation system of the present invention may advantageously provide a preparation table for holding food content that also serves as a lid for the pie iron molds, thereby providing the user with an easier means of preparing the food contents for placement within the pie iron. Further, the pie iron preparation system may advantageously comprise a deployed preparation configuration and a stored portable configuration, where the user may portably carry the pie iron preparation system in the stored portable configuration via an ergonomic hinged handle.

### BRIEF DESCRIPTION OF THE DRAWINGS

FIG. 1 illustrates a perspective view of a pie iron preparation system in a preparation configuration with a base substrate and a lid in an open configuration relative one another in accordance with some embodiments of the present invention.

FIG. 2 illustrates a perspective view of a pie iron preparation system in a table configuration with a base substrate and a lid in a closed configuration relative one another and legs in an extended configuration in accordance with some embodiments of the present invention.

FIG. 3 illustrates an overhead view of a pie iron preparation system in a stored portable configuration with a base substrate and a lid in a closed configuration relative one another and legs in a folded configuration in accordance with some embodiments of the present invention.

FIG. 4 illustrates a flow diagram of exemplary steps of a method of use of a pie iron preparation system in accordance with some embodiments of the present invention.

### DETAILED DESCRIPTION OF THE INVENTION

Before describing the present invention in detail, it is to be understood that the invention is not limited to any one of the particular embodiments, which of course may vary. It is also to be understood that the terminology used herein is for the purpose of describing particular embodiments only, and therefore is not necessarily intended to be limiting. As used in this specification and the appended claims, terms in the singular and the singular forms “a,” “an,” and “the” include plural referents unless the context clearly dictates otherwise. Thus, for example, reference to “a pie iron preparation system” also includes a plurality of pie iron preparation systems and the like.

In some embodiments, a pie iron preparation system is provided, comprising a base substrate having a first elongate length-to-width dimensional ratio, wherein: the base substrate comprises a top surface that comprises one or more pie iron depressions formed therein; and a lid having the first elongate length-to-width dimensional ratio, wherein: the lid comprises a plurality of walls disposed at a perimeter edge thereof, the plurality of walls surround a work surface disposed upon a first side of the lid, and one or more hinges operably couple the base substrate to the lid.

In some embodiments, a plurality of support legs are operably coupled to a bottom surface of the base substrate.

In some embodiments, the plurality of support legs are rotatably coupled to the bottom surface of the base substrate and rotate through an angle of at least 90 degrees relative the bottom surface of the base substrate.

In some embodiments, the plurality of support legs comprise one or more high-friction feet disposed at terminal ends of each of the support legs.

In some embodiments, the plurality of support legs comprise one or more horizontal crossbars, one or more vertical support bars and one or more terminal feet.

In some embodiments, the one or more pie iron depressions are recessed into the top surface and are shaped as a pie iron-shaped cavity.

In some embodiments, the one or more pie iron depressions each comprise a pie iron food container cutout portion and a pie iron elongate shaft cutout portion.

In some embodiments, the pie iron elongate shaft cutout portion is structured to frictionally retain an elongate shaft of a pie iron therein.

In some embodiments, the one or more pie iron depressions each comprise a layer of heat-robust non-stick material disposed thereupon.

In some embodiments, the layer of heat-robust non-stick material comprises polytetrafluoroethylene.

In some embodiments, the one or more hinges allow rotation of the base substrate through a 180 degree rotational angle relative the lid.

In some embodiments, the base substrate and the lid may be semi-permanently secured together via one or more latches.

In some embodiments, the base substrate or the lid comprises a rotatable handle operably coupled thereto.

In some embodiments, the work surface comprises a layer of high friction material disposed thereupon.

In some embodiments, the plurality of walls disposed at the perimeter edge of the lid surround each side of the base substrate when the base substrate and the lid are arranged in a closed configuration relative one another.

In some embodiments, the plurality of walls disposed at the perimeter edge of the lid are disposed adjacent a perimeter recessed lip of the base substrate when the base substrate and the lid are arranged in a closed configuration relative one another.

In some embodiments, the work surface comprises a layer of silicone, rubber, surfaced metal or any combination thereof.

In some embodiments, the base substrate or the lid are fabricated from powder coated aluminum.

In some embodiments, a pie iron preparation system is provided, comprising a base substrate having a first elongate length-to-width dimensional ratio, wherein: the base substrate comprises a top surface that comprises one or more pie iron depressions formed therein, and the one or more pie iron depressions are recessed into the top surface and are shaped as a pie iron-shaped cavity; and a lid having the first elongate length-to-width dimensional ratio, wherein: the lid comprises a plurality of walls disposed at a perimeter edge thereof, the plurality of walls surround a work surface disposed upon a first side of the lid, and one or more hinges operably couple the base substrate to the lid.

In some embodiments, a pie iron preparation system, comprising a base substrate having a first elongate length-to-width dimensional ratio, wherein: the base substrate comprises a top surface that comprises one or more pie iron depressions formed therein, the one or more pie iron depressions each comprise a pie iron food container cutout portion and a pie iron elongate shaft cutout portion, and the pie iron elongate shaft cutout portion is structured to frictionally retain an elongate shaft of a pie iron therein; and a lid having the first elongate length-to-width dimensional ratio, wherein: the lid comprises a plurality of walls disposed at a perimeter edge thereof, the plurality of walls surround a work surface disposed upon a first side of the lid, and one or more hinges operably couple the base substrate to the lid.

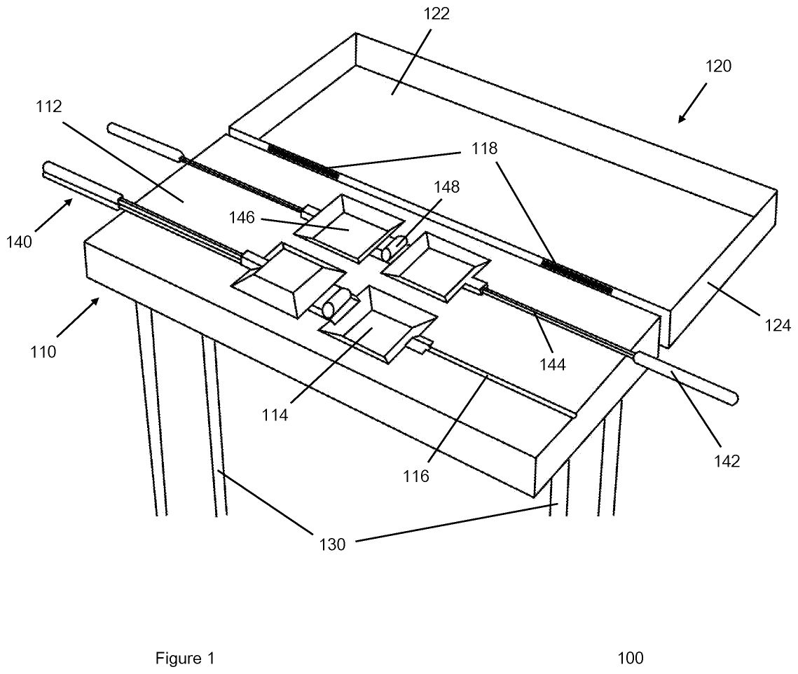

Exemplary embodiments of the present invention are illustrated in the accompanying figures. As shown in FIG. 1, a perspective view of a pie iron preparation system 100 in a preparation configuration with a base substrate 110 and a lid 120 in an open configuration relative one another is provided. The pie iron preparation system 100 may comprise the base substrate 110, the lid 120, a plurality of support legs 130 and at least one pie iron 140.

The base substrate 110 may comprise a planar top surface 112 that faces the lid 120 when in the closed configuration. The planar top surface 112 may comprise one or more pie iron molded depressions formed therein as shown in FIG. 1. Specifically, the pie iron molded depressions may comprise a food container cutout 114 that is shaped to conform to the largest typical dimensions of a food containing portion of a pie iron. Further, the pie iron molded depressions may compose an elongate shaft cutout 116 that is shaped to conform to the largest typical dimensions of an elongate shaft portion of a pie iron 140. Alternatively, the pie iron molded depressions may similarly be structured as impressions into the top surface 112.

Generally speaking, the one or more pie iron molded depressions may be in the shape of a pie iron 140 in an open configuration as illustrated in FIG. 1. Such a structural arrangement allows a user to build their pie food contents in the opened pie iron 140 on a stable surface prior to cooking the pie in the fire. Moreover, the one or more pie iron molded depressions also provides the user with a stable place to set down the high temperature pie iron 140 after cooking the pie food contents therein. Similarly, the stable surface allows easier removal of the pie food contents from the food container portion of the pie iron 140.

The base substrate 110 and the pie iron molded depressions may be fabricated from any suitable heat-robust material such as, but not limited to, common metals and polymers. In some embodiments, the base substrate 110 and the pie iron molded depressions may be fabricated from powder coated aluminum. Such a material selection and other similarly situated materials of like characteristics would be advantageous given the lightweight yet structurally robust nature of the material. This would provide the user with a lighter load to carry when transporting the pie iron preparation system 100 and further gives the user confidence in the load-bearing capacity of the system 100. Additionally, each of the base substrate 110 and the lid 120 may comprise a first elongate length-to-width dimensional ratio that provides the system 100 with the ability to house the pie irons therein while still being highly portable and minimizing material cost.

Each of the pie iron molded depressions formed within the top surface 112 may be coated with one or more layers of a low-friction and heat-robust materials such as polytetrafluoroethylene or like polymers. Such materials being used in the pie iron molded depressions will allow for any loose food scraps that are spilled from the pie iron 140 into the depressions to be easily cleaned like a non-stick cooking pan. Further, a pie iron 140 that has just been removed from a fire will have a very high surface temperature and so a thermally-robust material is necessary to prevent damage being done to the depressions. Similarly, the top surface 112 may comprise a similar coating of low-friction, heat-robust materials so that the high heat and food contents of the pie iron 140 do not structurally or aesthetically damage the base substrate 110 structure while also providing an easy cleanup in the event hot food contents are spilled onto the top surface 112.

The base substrate 110 may be coupled to a lid 120 via one or more rotatable hinges 118. The rotatable hinges 118 may allow the base substrate 110 and the lid 120 to be manipulated between open and closed configurations. Specifically, the one or more rotatable hinges 118 may allow the base substrate 110 and the lid 120 to rotate relative one another through a rotational angle of at least 180 degrees about an axis running through each hinges 118. FIG. 1 illustrates the base substrate 110 and the lid 120 to be in the open configuration relative one another. In the open configuration, the base substrate 110 and the lid 120 may be arranged such that they are arranged next to one another in succession in the horizontal direction. In other words, the base substrate 110 and the lid 120 may be arranged parallel one another within a common horizontal plane.

In the closed configuration, the base substrate 110 and the lid 120 may be arranged such that the lid 120 is stacked vertically upon the base substrate 110. In other words, the base substrate 110 and the lid 120 may be arranged parallel one another in parallel stacked planes. Further, In the closed configuration, the planar top surface 112 and a work surface 122 of the lid 120 may be in physical contact with one another or at least disposed directly adjacent one another. Moreover, in some embodiments, the inner portions of one or more walls 124 of the lid 120 may be disposed in physical contact or at least directly adjacent the outer portions of one or more side walls of the base substrate 110. In other embodiments, the base substrate 110 may comprise a perimeter recessed lip formed into the outer edge thereof to structurally accommodate an outer edge lip of the lid 120. Such structural arrangements may enable the pie iron preparation system 100 to define a smaller dimensional form factor and therefore provides the pie iron preparation system 100 with a greater degree of portability when in a stored portable configuration.

Additionally, the lid 120 may be manipulated as desired between the open and closed configurations. When in the closed configuration, the lid 120 may be semi-permanently secured to the base substrate 110 via one or more locking mechanisms such as, but not limited to, a latch or the like. The one or more locking mechanisms may prevent the base substrate 110 and the lid 120 from being manipulated into the open configuration. Upon release of the locking mechanisms, however, the base substrate 110 and the lid 120 may then freely assume the open or closed positions as desired by the user.

The work surface 122 of the lid 120 may comprise one or more frictional surface materials disposed thereon. The one or more frictional surface materials may comprise, but are not limited to, silicone, rubber, surfaced metals and the like or any combination thereof. These materials would be advantageous as they provide a high-friction surface to prevent the unintended sliding of food items and containers across the work surface 122 while still providing an easy-cleaning surface in the event of spilled food items thereupon. In use, the work surface 122 may be utilized to prepare the food contents for later insertion into the pie iron 140.

The one or more walls 124 of the lid 120 may similarly comprise the same one or more frictional surface materials disposed thereon as the work surface 122 for similar motivational reasons. In use, the one or more walls 124 may be utilized in order to maintain the food items and containers upon the work surface 122 during preparation of the food contents for later insertion into the pie iron 140.

The plurality of support legs 130 may each be operably coupled to the underside of the base substrate 110. Each of the plurality of support legs 130 may be structurally designed to bear the load of the remainder of the pie iron preparation system 100 including the base substrate 110, lid 120, and all associated structural elements including any items placed thereupon such as food items and pie irons 140. Therefore, the plurality of support legs 130 may be fabricated in pairs to allow each pair of support legs 130 to be structurally robust against heavy loads and to be stable on uneven ground surfaces which are often encountered in rugged outdoor environments like campsites.

Additionally, each support leg 130 in each pair of support legs 130 may be arranged at an angle relative one another in order to support added weight on the lid 120 when the base substrate 110 and the lid 120 are arranged in the open configuration given the lid 120 is off-center relative the support legs 130 coupling point on the base substrate 110 in this configuration. Specifically, the support legs 130 may be angled towards the lid 120 relative one another in order to provide added load-bearing capacity and a more stable support structure for the pie iron preparation system 100. Further, the support legs 130 may each be telescoping in nature to allow the support legs 130 to extend into the extended load-bearing orientation and to retract and/or fold back into the portable stored configuration.

The pie irons 140 may comprise at least one handle portion 142, at least one shaft portion 144, at least one food container portion 146 and a hinge portion 148. In some embodiments, the hinge portion 148 may rotatably couple together symmetrically identical handle portions 142, shaft portions 144 and food container portions 146. As illustrated in FIG. 1, the two food container portions 146 may join together to form a sealed food container portion as illustrated in the pie iron 140 furthest from the lid 120. In use, the user may handle the pie iron 140 via the handle portion 142 in order to manipulate the pie iron between the open and closed configurations. Further, the user may load the food container portion 146 with food items when in the open configuration and then may seal the food items within the food container portion 146 in the closed configuration. Moreover, the user may use the handle portions 142 to place the sealed pie iron 140 into the heated environment such as a fire. The shaft portions 144 ensure that the user is not harmed by the heat of the fire but rather is able to maintain a safe distance therefrom.

In some embodiments, the pie iron preparation system 100 may be utilized as a mechanism to transport one or more pie irons 140 when the base substrate 110 and the lid 120 are in the closed configuration relative one another. Specifically, the pie irons 140 may be placed in the open configuration within the pie iron depressions of the top surface 112 and then the lid 120 closed over the base substrate 110 such that the handles 142 may protrude from the ends of the base substrate 110. Further, if necessary, the walls 124 of the lid 120 may include one or more notches therein along their edges to accommodate the elongate shafts 144 extending from the edge of the base substrate 110.

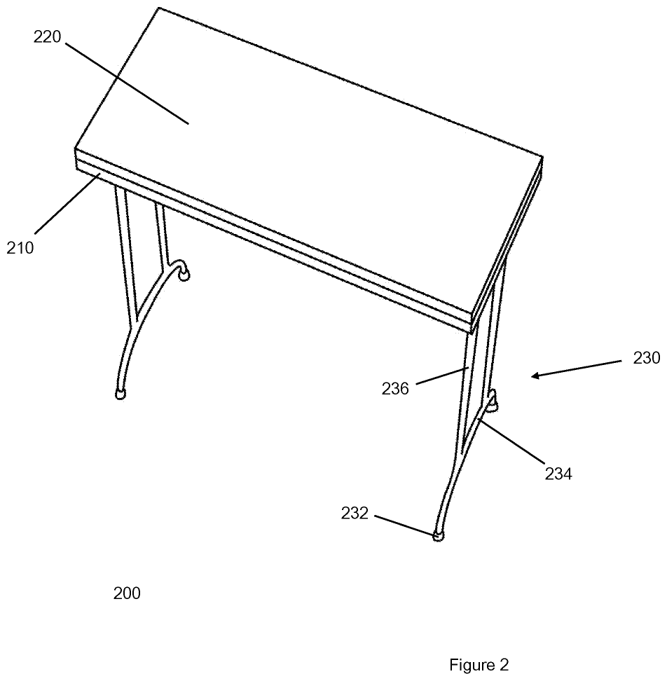

As shown in FIG. 2, a perspective view of a pie iron preparation system 200 in a table configuration with a base substrate 210 and a lid 220 in a closed configuration relative one another and support legs 230 in an extended configuration is provided. The pie iron preparation system 200 in the closed configuration may comprise the base substrate 210, the lid 220 and the support legs 230.

In some embodiments as illustrated in FIG. 2, the base substrate 210 and the lid 220 in the closed configuration may be arranged in parallel without overlapping outer edges. In other embodiments, the base substrate 210 and the lid 220 may comprise overlapping outer edges as previously explained with reference to FIG. 1. In the illustrated embodiment, a horizontal line is shown as dividing the base substrate 210 portion of the pie iron preparation system 200 from the lid 220 portion.

One embodiment of the support legs 230 is illustrated in detail in FIG. 2 and may comprise terminal feet 232, horizontal crossbars 234 and vertical support bars 236. The terminal feet 232 may each comprise one or more high friction materials such as robust rubber materials, robust polymer materials and the like or any combination thereof which may provide stability between the pie iron preparation system 200 and the ground surface upon which it rests.

The horizontal crossbars 234 may be coupled to both the terminal feet 232 and the vertical support bars 236 in order to provide further stability to the pie iron preparation system 200 against horizontal shear forces applied thereto. The vertical support bars 236 may be coupled to the base substrate 210 and the horizontal crossbars 234 and be utilized in order to make the pie iron preparation system 200 robust against vertical forces.

Each of the horizontal crossbars 234 and the vertical support bars 236 of the support legs 230 may be fabricated from any suitable robust metal or polymer materials such as, but not limited to, powder coated aluminum, stainless steel or alloys thereof and the like or any combination thereof. Such materials would provide the necessary structural strength for the pie iron preparation system 200 while not needlessly adding weight to the system 200 and making it difficult for the average user to transport in rugged terrain, such as at a campsite.

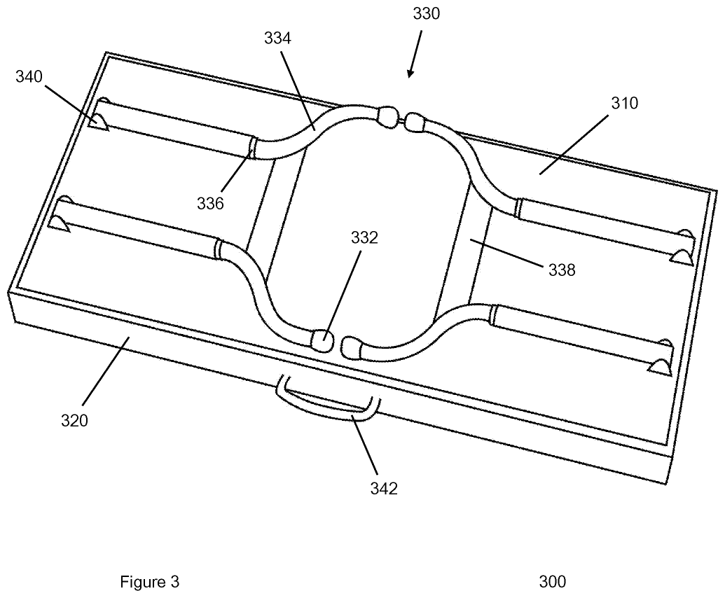

As shown in FIG. 3, an overhead view of a pie iron preparation system 300 in a stored portable configuration with a base substrate 310 and a lid 320 in a closed configuration relative one another and support legs 330 in a folded portable stored configuration is provided. The pie iron preparation system 300 in the stored portable configuration may comprise the base substrate 310, the lid 320 and the support legs 330.

In some embodiments as illustrated in FIG. 3, the base substrate 310 and the lid 320 in the stored portable configuration may be arranged in parallel with overlapping outer edges. In other embodiments, the base substrate 310 and the lid 320 may comprise non-overlapping outer edges as previously explained with reference to FIG. 2. In the illustrated embodiment, a square outline is shown as dividing the outer walls of the base substrate 310 portion from the inner walls of the lid 320 portion of the pie iron preparation system 300.

One embodiment of the support legs 330 is illustrated in detail in FIG. 3 and may comprise terminal feet 332, lower support bars 334, telescoping mechanisms 336, horizontal crossbars 338, base substrate coupling mechanisms 340 and a hinged handle 342. The terminal feet 332 may each comprise one or more high friction materials such as robust rubber materials, robust polymer materials and the like or any combination thereof which may provide stability between the pie iron preparation system 300 and the ground surface upon which it rests.

The horizontal crossbars 338 may be coupled to the lower support bars 334 in order to provide further stability to the pie iron preparation system 300 against horizontal shear forces applied thereto. The vertical support bars may be coupled to the base substrate 310 and the horizontal crossbars 338 and be utilized in order to make the pie iron preparation system 300 robust against vertical forces.

The base substrate coupling mechanisms 340 may be utilized to couple the support legs 330 to the underside of the base substrate 310 as shown in FIG. 3. Further, the structure of the base substrate coupling mechanisms 340 may allow for the support legs 330 to rotate relating the base substrate 310. Specifically, the coupling mechanisms 340 may allow the support legs 330 to rotate through an angle of at least 90 degrees so that the support legs 330 may assume the stored portable configuration at an angle of 0 degrees parallel relative the base substrate 330 bottom surface and the extended load-bearing configuration at an angle of 90 degrees orthogonal relative the base substrate 330 bottom surface.

In some embodiments, the base substrate coupling mechanisms 340 may provide a means for the support legs 330 to be locked into place once the support legs 330 are arranged in the extended load-bearing configuration. Alternatively, the base substrate coupling mechanisms 340 may be utilized in conjunction with one or more diagonal support hinges (not shown) that may selectively lock the support legs 330 into the extended load-bearing configuration, thereby structurally preventing the support legs 330 from being manipulated back into the folded state which would otherwise cause a safety concern for the user. The diagonal support hinges may be structured and may function in a similar manner to those found on typical folding tables, where the hinges are manually placed into a locking configuration to secure the table and manually placed into an unlocked configuration when the table is to be folded and stored.

The hinged handle 342 may be utilized by the user to pick up the entirety of the pie iron preparation system 300 and transport it as desired. The hinge of the hinged handle 342 may allow the handle 342 to rotate through an angle of 180 degrees relative an outer wall surface of the lid 320. Such a design may allow the pie iron preparation system 300 to be ergonomically handled in rugged environmental terrain such as that found in backcountry campsites.

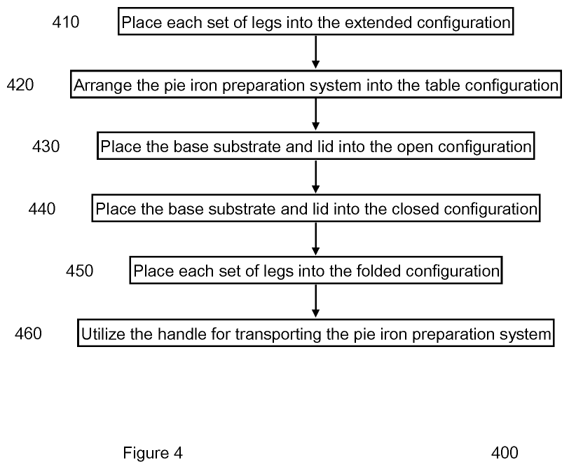

As shown in FIG. 4, a flow diagram of exemplary steps of a method 400 of use of a pie iron preparation system is provided. However, it is understood that the pie iron preparation system may be used according to any order of the following steps. At step 410, a user may place each set of support legs into the extended load-bearing configuration. At step 420, the user may manipulate the pie iron preparation system into the table configuration by having each of the support legs in contact with a ground surface.

Further, at step 430, the user may place the base substrate and the lid into the open configuration relative one another. At step 440, the user may place the base substrate and the lid into the closed configuration relative one another after the user is done making use of the pie iron preparation system in the open configuration. At step 450, the user may place each set of support legs into the folded portable closed configuration for transport. At step 460, the user may utilize the hinged handle for actively transporting the pie iron preparation system in the folded portable closed configuration.

In some embodiments of FIGS. 1-4, the lid of the pie iron preparation system may comprise one or more cupholders, storage compartments, high-friction surface materials and the like or any combination thereof. Additionally, the pie iron molded depressions may be shaped to accommodate any range of typical sizes of third-party pie irons, but preferably is sized to accommodate even the largest of produced pie irons on the market, thereby providing the ability to retain large pie irons and small pie irons within the same pie iron molded depression.

Alternatively, a first large-sized pie iron molded depression and a second medium or small-sized pie iron molded depression may be utilized in associated with the pie iron preparation system in order to provide snug-fitting pie iron molded depressions for users having either a large-sized pie iron or a standard or smaller-sized pie iron, thereby increasing the market reach of the pie iron preparation system. Additionally, the pie iron molded depressions may comprise a snap-fit structure within the portion of the molded depression that secures the shaft portion of the given pie iron, thereby securing the pie iron in place while allowing the food container portion to not be in contact with the molded depression of the base substrate so as not to damage the base substrate with excess heat after removal from a fire or other thermal energy source.

The specification and drawings are to be regarded in an illustrative rather than a restrictive sense. However, it will be evident that various modifications and changes may be made thereunto without departing from the broader spirit and scope of the invention as set forth in the claims. Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a,” “an,” “the,” and similar referents in the context of describing the disclosed embodiments (especially in the context of the following claims) are to be construed to cover both the singular and the plural, unless otherwise indicated or clearly contradicted by context. The terms “comprising,” “having,” “including,” and “containing” are to be construed as open-ended terms (i.e., meaning “including, but not limited to,”) unless otherwise noted. The term “connected,” where unmodified and referring to physical connections, is to be construed as partly or wholly contained within, attached to, or joined together, even if there is something intervening. Recitation of ranges of values are merely intended to serve as a shorthand method of referring individually to each separate value falling within the range, unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” is understood with the context as used in general to present that an item, term, etc., may be either A or B or C, or any nonempty subset of the set of A and B and C, unless specifically stated otherwise or otherwise clearly contradicted by context. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). The number of items in a plurality is at least two, but can be more when so indicated either explicitly or by context.

The use of any examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, although above-described elements may be described in the context of certain embodiments of the specification, unless stated otherwise or otherwise clear from context, these elements are not mutually exclusive to only those embodiments in which they are described; any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

1. A pie iron preparation system, comprising:
a base substrate having a first elongate length-to-width dimensional ratio, wherein:
the base substrate comprises a top surface that comprises one or more pie iron depressions formed therein; and
a lid having the first elongate length-to-width dimensional ratio, wherein:
the lid comprises a plurality of walls disposed at a perimeter edge thereof,
the plurality of walls surround a work surface disposed upon a first side of the lid, and
one or more hinges operably couple the base substrate to the lid.

2. The pie iron preparation system of claim 1, wherein a plurality of support legs are operably coupled to a bottom surface of the base substrate.

3. The pie iron preparation system of claim 2, wherein the plurality of support legs are rotatably coupled to the bottom surface of the base substrate and rotate through an angle of at least 90 degrees relative the bottom surface of the base substrate.

4. The pie iron preparation system of claim 2, wherein the plurality of support legs comprise one or more high-friction feet disposed at terminal ends of each of the support legs.

5. The pie iron preparation system of claim 2, wherein the plurality of support legs comprise one or more horizontal crossbars, one or more vertical support bars and one or more terminal feet.

6. The pie iron preparation system of claim 1, wherein the one or more pie iron depressions are recessed into the top surface and are shaped as a pie iron-shaped cavity.

7. The pie iron preparation system of claim 1, wherein the one or more pie iron depressions each comprise a pie iron food container cutout portion and a pie iron elongate shaft cutout portion.

8. The pie iron preparation system of claim 7, wherein the pie iron elongate shaft cutout portion is structured to frictionally retain an elongate shaft of a pie iron therein.

9. The pie iron preparation system of claim 1, wherein the one or more pie iron depressions each comprise a layer of heat-robust non-stick material disposed thereupon.

10. The pie iron preparation system of claim 9, wherein the layer of heat-robust non-stick material comprises polytetrafluoroethylene.

11. The pie iron preparation system of claim 1, wherein the one or more hinges allow rotation of the base substrate through a 180 degree rotational angle relative the lid.

12. The pie iron preparation system of claim 1, wherein the base substrate and the lid may be semi-permanently secured together via one or more latches.

13. The pie iron preparation system of claim 1, wherein the base substrate or the lid comprises a rotatable handle operably coupled thereto.

14. The pie iron preparation system of claim 1, wherein the work surface comprises a layer of high friction material disposed thereupon.

15. The pie iron preparation system of claim 1, wherein the plurality of walls disposed at the perimeter edge of the lid surround each side of the base substrate when the base substrate and the lid are arranged in a closed configuration relative one another.

16. The pie iron preparation system of claim 1, wherein the plurality of walls disposed at the perimeter edge of the lid are disposed adjacent a perimeter recessed lip of the base substrate when the base substrate and the lid are arranged in a closed configuration relative one another.

17. The pie iron preparation system of claim 1, wherein the work surface comprises a layer of silicone, rubber, surfaced metal or any combination thereof.

18. The pie iron preparation system of claim 1, wherein the base substrate or the lid are fabricated from powder coated aluminum.

19. A pie iron preparation system, comprising:
a base substrate having a first elongate length-to-width dimensional ratio, wherein:
the base substrate comprises a top surface that comprises one or more pie iron depressions formed therein, and
the one or more pie iron depressions are recessed into the top surface and are shaped as a pie iron-shaped cavity; and
a lid having the first elongate length-to-width dimensional ratio, wherein:
the lid comprises a plurality of walls disposed at a perimeter edge thereof,
the plurality of walls surround a work surface disposed upon a first side of the lid, and
one or more hinges operably couple the base substrate to the lid.

20. A pie iron preparation system, comprising:
a base substrate having a first elongate length-to-width dimensional ratio, wherein:
the base substrate comprises a top surface that comprises one or more pie iron depressions formed therein,
the one or more pie iron depressions each comprise a pie iron food container cutout portion and a pie iron elongate shaft cutout portion, and
the pie iron elongate shaft cutout portion is structured to frictionally retain an elongate shaft of a pie iron therein; and
a lid having the first elongate length-to-width dimensional ratio, wherein:
the lid comprises a plurality of walls disposed at a perimeter edge thereof,
the plurality of walls surround a work surface disposed upon a first side of the lid, and
one or more hinges operably couple the base substrate to the lid.
